(19) United States
(12) Patent Application Publication
(10) Pub. No.: US 2010/0211261 A1
(43) Pub. Date: Aug. 19, 2010

(54) VEHICLE BEHAVIOR CONTROL SYSTEM

(75) Inventors: Hiroaki SASAKI, Wako (JP); Takashi Tsujioka, Wako (JP); Takashi Nishimori, Wako (JP); Hitoshi Sasaki, Wako (JP); Toshimitsu Kaji, Wako (JP); Tetsuro Hara, Wako (JP)

Correspondence Address: ARENT FOX LLP, 1050 CONNECTICUT AVENUE, N.W., SUITE 400, WASHINGTON, DC, 20036, US

(73) Assignee: HONDA MOTOR CO., LTD., Tokyo (JP)

(21) Appl. No.: 12/705,316

(22) Filed: Feb. 12, 2010

(30) Foreign Application Priority Data
Feb. 10, 2009 (JP) JP2009-028035

(51) Int. Cl. B60G 17/018

(52) U.S. Cl. 701/37

(57) ABSTRACT

Provide is a vehicle behavior control system that can achieve a rear wheel steering control demonstrating a high rate of response at all times without requiring the actuator for the rear wheels to be steered to be unduly increased. A control unit (20) for controlling the rear wheel steering angle is configured to reduce the effective stiffness of the rear wheel suspension systems while increasing the effective stiffness of the front wheel suspension systems when an increase in the road contact load of one of the rear wheels is detected or estimated. Thereby, an actuator (8) for the rear wheel is enabled to steering the rear wheels without involving any undue time delay with a minimum power requirement.

### TECHNICAL FIELD

The present invention relates to a vehicle behavior control system for a multi-wheel motor vehicle equipped with arrangements for controlling the steering of the vehicle and the contact load of each wheel, and in particular to a vehicle behavior control system that allows the steering of the vehicle to be effected in a favorable manner even when the contact load of the wheel to be steered has increased typically owing to the operating condition of the vehicle.

### BACKGROUND OF THE INVENTION

Various four-wheel steering vehicles, as opposed to the more conventional vehicles which are capable steering only the front wheels in response to the turning of a steering wheel, have been proposed with the aim of improving the motion stability of the vehicle at high speeds and reduce the turning radius of the vehicle at low speeds. See Japanese patent laid open publication No. 7-33036 (patent document 1) and Japanese patent laid open publication No. 2008-174066 (patent document 2). In a typical four-wheel steering vehicle, the rear wheels are steered in the opposite phase relationship to the front wheels at low speeds and in the same phase relationship by using a rear wheel steering actuator under the control of a rear wheel steering control system.

It has also been proposed to use variable damping force dampers that allow the damping forces to be varied depending on the operating condition of the vehicle with the aim of improving the motion stability and ride quality of the vehicle at the same time. Such a damper is typically constructed not much different from a hydraulic damper used in more conventional wheel suspension systems, but is configured to vary the damping force that is produced for a given stroke speed thereof. See Japanese patent laid open publication No. 2006-273223 (patent document 3), for instance. Some of the current vehicles use active suspension systems using air springs that are actively controlled according to the skyhook theory. See Japanese patent laid open publication No. 2004-149046 (patent document 4), for instance. By changing the damping force of a variable damper or changing the air pressure of an air spring of an active suspension system, the road contact load of the corresponding wheel can be changed.

In a rear wheel steering system of a four-wheel steering vehicle, a target steering angle of each rear wheel is determined from various control parameters (such as the front wheel steering angle, vehicle speed, target yaw rate and so on), and the rear wheel steering actuators are actuated so as to make the actual rear wheel steering angles agree with the respective target rear wheel steering angles. However, when the vehicle is subjected to a high lateral acceleration as is the case when the vehicle is cornering at a high speed, the road contact load of one of the rear wheels increases, and this increases the load on the rear wheel steering actuator for the corresponding rear wheel. Therefore, to achieve a highly responsive rear wheel steering angle control, each rear wheel steering actuator is required to have an adequate power output so as to readily overcome the frictional resistance caused by the increased road contact, and provide a desired high rate of response even when the conceivably greatest load is applied to the rear wheel. This necessitates an undesired increase in the size of the actuator.

### BRIEF SUMMARY OF THE INVENTION

In view of such problems of the prior art, a primary object of the present invention is to provide a vehicle behavior control system that can achieve a steering control demonstrating a high rate of response at all times without requiring the actuator for the wheel to be steered to be unduly increased.

According to the present invention, such an object can be accomplished at least partly by providing a vehicle behavior control system for a vehicle including a pair of front wheels configured to be steered by a vehicle operator and a pair of rear wheels configured to be steered by a steering actuator, comprising: a wheel suspension system supporting each wheel, the wheel suspension system including a variable wheel suspension element that can change an effective stiffness of the corresponding wheel suspension system; a first sensor for detecting an operating condition of the vehicle; a second sensor for detecting an increase in a road contact load of each rear wheel; and a control unit that actuates the steering actuator according to an operating condition of the vehicle detected by the first sensor; wherein the control unit is configured to reduce the effective stiffness of the variable wheel suspension element corresponding to at least one of the rear wheels, preferably the effective stiffness of the variable wheel suspension elements of both the rear wheels in relation to the effective stiffness of the variable wheel suspension elements corresponding to the front wheels (or the effective roll stiffness of the front wheels), for instance without changing the effective stiffness of the front wheel, when the second sensor has detected an increase in the road contact load of one of the rear wheels.

Thereby, when the road contact load of one of the rear wheels is increased typically owing to a high lateral acceleration caused by a high speed cornering and this rear wheel is required to be steered at the same time, the road contact load of the rear wheel can be temporarily reduced by decreasing the roll stiffness of a rear part of the vehicle so that the torque required for steering the rear wheel can be adequately reduced, and may be returned to an appropriate level for the required attitude control of the vehicle when the wheel is not being steered. Therefore, the actuator for steering the rear wheel is required to have a relatively low torque output that is adequate only when a normal contact load is acting upon the rear wheel, and can still steer the rear wheel at a high rate of response at all times.

According to a particularly preferred embodiment of the present invention, the control unit increases the effective stiffness of the variable wheel suspension elements corresponding the front wheels at the same time as decreasing the effective stiffness of the variable wheel suspension elements corresponding the rear wheels when the second sensor has detected an increase in the road contact load of one of the rear wheels. In particular, when the increase in the road contact load of one of the rear wheels is caused by a cornering movement of the vehicle, the changes in the suspension stiffness may be effected in such a manner that a roll angle of the vehicle remains substantially unchanged by the increasing and decreasing of the effective stiffness of the variable suspension elements.

In order to avoid frequent unnecessary changes in the stiffness in the wheel suspension systems, the increasing and decreasing of the effective stiffness of the variable suspension elements by the control unit may be performed only when a deviation of an actual rear wheel steering angle effected by the actuator from a target rear steering angle commanded by the control unit is greater than a prescribed value. Also, the increasing and decreasing of the effective stiffness of the variable suspension elements by the control unit should be performed only if a deviation of an actual rear wheel steering angle effected by the actuator from a target rear steering angle commanded by the control unit has become greater than a prescribed value due to an increase in the lateral acceleration of the vehicle. If the response delay in the steering of the one rear wheel is not caused by the lateral acceleration of the vehicle, the increasing and decreasing of the effective stiffness of the variable suspension elements may not resolve the problem of the delayed response of the one rear wheel so that the controlling the stiffness of the wheel suspension systems is not likely to be of benefit, and may even impair the stability and ride quality of the vehicle.

The variable wheel suspension element may comprise a variable damping force damper or an active wheel suspension element (such as a hydraulic cylinder, a pneumatic cylinder and an air spring that is combined with a suitable power or pressure source, and may also be used for changing the height of the corresponding height of the vehicle) which is normally used for controlling the motion stability and ride quality of the vehicle.

### BRIEF DESCRIPTION OF THE DRAWINGS

Now the present invention is described in the following with reference to the appended drawings, in which:

FIG. 1 is a diagram four-wheel motor vehicle embodying the present invention;

FIG. 2 is a block diagram showing an essential part of an ECU used in a control system of the preferred embodiment of the present invention;

FIG. 3 is a flowchart showing the control process of reducing the contact load;

FIGS. 4A and 4B are graphs showing the frequency properties of the yaw rate and rear wheel steering angle response;

FIG. 5 is a graph showing the frequency properties of the lateral acceleration and rear wheel steering angle response;

FIG. 6 is a graph showing the frequency properties of the roll angle and rear wheel steering angle response;

FIGS. 7A and 7B are a perspective view and front view of a vehicle model for illustrating the shifting of load in a four-wheel motor vehicle in the embodiment of the present invention; and

FIG. 8 is a view similar to FIG. 3 showing a second embodiment of the present invention.

### DETAILED DESCRIPTION OF THE PREFERRED EMBODIMENTS

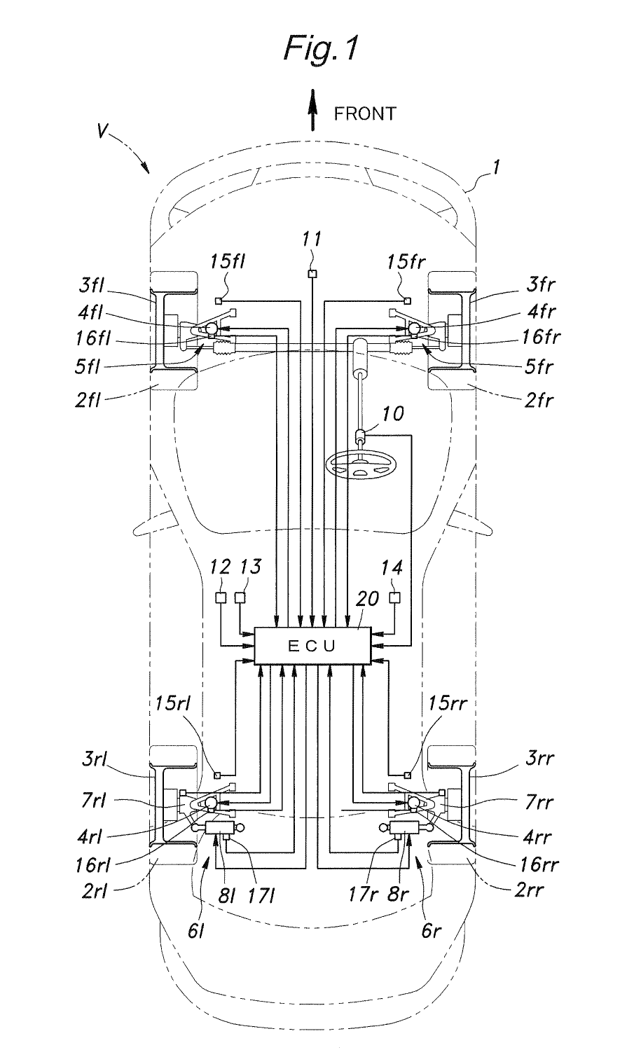

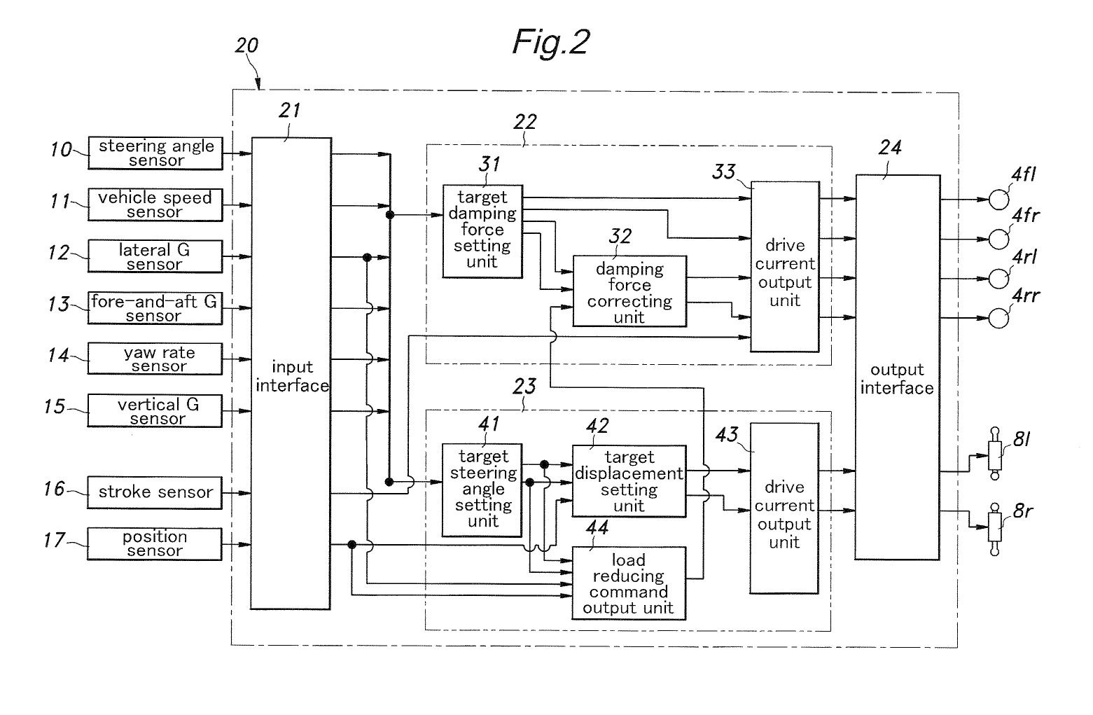

FIG. 1 is a simplified diagram of a four-wheel passenger vehicle to which the present invention is applied. In FIG. 1, some of the component parts are associated with each wheel, and such component parts are denoted with suffices fl, fr, rl and rr to indicate with which wheel the particular component is associated. For instance, a front left wheel is denoted with 3fl, a front right wheel with 3fr, a rear left wheel with 3rl and rear right wheel with 3rr. When a particular component is collectively referred to, it may be denoted with the corresponding numeral without the suffix. For instance, the wheels of the vehicle may be referred to simply as “3” depending on the situation.

Referring to FIG. 1, the illustrated vehicle V has a vehicle body 1 which is fitted with four wheels 3. Each wheel 3 is supported by the vehicle body 1 via a wheel suspension system 5 that includes suspension arms, a spring and a hydraulic damper 4. The vehicle body 1 is further provided with a pair of rear wheel steering mechanisms 6 associated with the two rear wheels 3rl, 3rr, respectively, and an ECU (electronic control unit) 20 for controlling the dampers 4 and rear wheel steering mechanisms 6.

Each damper 4 essentially consists of a telescopic piston and cylinder, and uses MRF (magneto-rheological fluid) for the working fluid thereof. (Refer to copending U.S. patent application Ser. No. 11/954,292 published under US2008-0251982A1 for more details of such variable dampers.) Therefore, the damping force of each damper 4 can be continually and quickly changed by controlling the supply of electric current to an MRF valve incorporated in the piston of the damper 4. A rear wheel steering actuator 8 consisting of a linear actuator is interposed between the vehicle body 1 and a knuckle 7 of each rear wheel 3rl, 3rr so that the two rear wheels 3rl and 3rr can be individually steered by controlling the supply of electric current to the rear wheel steering actuators 8.

The vehicle V is provided with a steering angle sensor 10 for detecting a steering angle of a steering wheel, a vehicle speed sensor 11 for detecting a traveling speed of the vehicle, a lateral G sensor 12 for detecting a lateral acceleration of the vehicle, a fore-and-aft G sensor 13 for detecting a fore-and-aft acceleration of the vehicle and a yaw rate sensor 14 for detecting the yaw rate of the vehicle V. A vertical G sensor is provided in association with each wheel so that a vertical acceleration of a wheel house or a part adjacent thereto may be detected, and each damper 4 is provided with a stroke sensor 16 for detecting a damper stroke. Each rear wheel steering actuator 8 is fitted with a position sensor (linear encoder) 17 for detecting an actual displacement output thereof (or the steering angle of the corresponding rear wheel).

The ECU 20 is formed of a microcomputer configured to execute a prescribed computer program with the aid of ROM, RAM, a peripheral circuit, an input/output interface and various drivers, and is connected to the dampers 4 and the various sensors 10 to 17 via a communication line such as CAN (controller area network) as shown in FIG. 1. The ECU 20 comprises an input interface 21 that receives the detection signals of the various sensors 10 to 17, a damping force control unit 22 for controlling the damping forces of the dampers 4, a rear wheel steering control unit 23 for controlling the operation of the rear wheel steering actuators 8 and an output interface 24 for outputting the drive currents determined by the damping force control unit 22 and rear wheel steering control unit 23.

The damping force control unit 22 comprises a target damping force setting unit 31 that determines the target damping force of each damper 4 according to the detection signals of the various sensors 10 to 15, a damping force correcting unit 32 for correcting the target damping force of each rear wheel damper 4rl, 4rr set by the target damping force setting unit 31 according to a load reduction command forwarded from the rear wheel steering control unit 23 (as will be described hereinafter) and a drive current output unit 33 for outputting a drive current for each damper 4 according to the corrected target damping force given by the damping force correcting unit 32 and the stroke speed of the corresponding damper detected by the corresponding stroke sensor 16.

The rear wheel steering control unit 23 comprises a target steering angle setting unit 41 that determines a reference yaw rate according to the detection signals of the steering angle sensor 10 and yaw rate sensor 14 and sets a target rear wheel steering angle that is required to achieve the reference yaw rate, a target displacement setting unit 42 that determines a target displacement of each rear wheel steering actuator 8 according to the difference between the rear wheel target steering angle set by the target steering angle setting unit 41 and actual rear wheel steering angle received from the position sensor 17, a load reducing command output unit 44 that produces the load reduction command (which is forwarded to the damping force correcting unit 32) according to the rear wheel target steering angle set by the target steering angle setting unit 41, actual rear wheel steering angle detected by the position sensor 17 and lateral acceleration Gy detected by the lateral G sensor 12, and a drive current output unit 43 that supplies a drive current to each rear wheel steering actuator 8 according to the target displacement set by the target displacement setting unit 42.

When the vehicle V starts operation, the ECU 20 executes a damping force control and a rear wheel steering control at a prescribed regular control interval (2 ms, for instance).

In executing the damping force control, the ECU 20 determines the driving condition of the vehicle V according to the detection signals of the various sensors 10 to 15, and computes the corresponding skyhook control value, roll control value and pitch control value according to the determined driving condition of the vehicle V. The ECU 20 then selects, for each wheel 3, one of the control values that has the same sign as the stroke speed of the damper 4 and has the greatest absolute value of them as the target damping force. A target current value is looked up from a target current map according to the target damping force and stroke speed, and the corresponding electric current is supplied to the corresponding damper 4. (Refer to copending U.S. patent application Ser. No. 11/987,950 published under US2008-0140285A1 for more details of such variable damper control processes.)

In executing the rear wheel steering control, the ECU 20 looks up a target steering angle (target rear wheel steering angle) for each rear wheel 3rl, 3rr from a target steering angle map according to the detection signals of the steering angle sensor 10 and yaw rate sensor 14. A target displacement for each rear wheel steering actuator 8 is determined from the difference between the rear wheel target steering angle and the actual rear wheel steering angle received from the position sensor 17, and is forwarded to the rear wheel steering actuator 8.

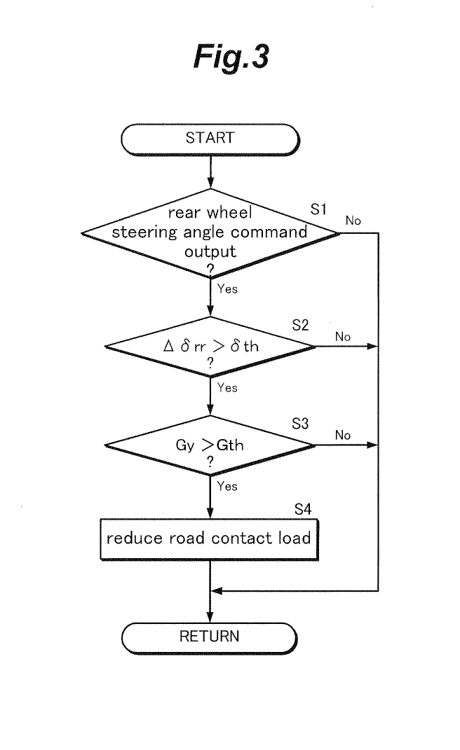

The contact load reduction control of the illustrated embodiment is described in the following with reference to the flowchart given in FIG. 3. The contact load reduction control of the illustrated embodiment is executed for each wheel in a similar manner, and for the simplification of description, only the control process for the right rear wheel 3rr which corresponds to the outer wheel when the vehicle is cornering is given in the following.

Concurrently with the execution of the damping force control and rear wheel steering control, the ECU 20 executes the contact load reduction control as shown in FIG. 3. Upon starting the contact load reduction control, in step S1, it is determined if a rear wheel steering command has been issued (or if a drive current has been supplied to the rear wheel steering actuator 8r). If the determination result is No, the program flow returns to the start.

When a rear wheel steering command has been issued as is typically the case when the vehicle V is cornering or executing a slalom maneuver, the determination result of step S1 becomes Yes, and it is determined if the difference Δδrr between the rear wheel target steering angle δrrt and actual rear wheel steering angle δrrr has exceeded a prescribed threshold value δrth in step S2. If this determination result of step S2 is No, the program flow directly returns to the start. Thereby, the contact load reduction control is prevented from being invoked unnecessarily. As the contact load reduction control may disturb the normal wheel suspension control of the vehicle, it is desirable restrict the condition under which the contact load reduction control is initiated.

The determination result of step S2 becomes Yes typically when the contact load of the right rear wheel 3rr has increased and the resulting increase in the steering resistance prevented the rear wheel steering actuator 8r from responding promptly to a target rear steering angle. In such a case, it is determined in step S3 if the lateral acceleration Gy detected by the lateral G sensor 18 has exceeded a determination threshold value Gyth or, in other words, if the cause of the increase in the difference Δδrr between the rear wheel target steering angle δrrt and actual rear wheel steering angle δrrr is attributed to the increase in the contact load owing to the lateral acceleration. If this determination result is No, the program flow returns to the start. If the increase in the difference Δδrr is due to other causes such as a mechanical or electrical failure of the rear wheel steering actuator 8r, the reducing the contact load of the right rear wheel 3rr is not effective in reducing the difference Δδrr, and may even impair the attitude of the vehicle.

If the determination result of step S3 is Yes, a contact load reduction command is forwarded to the damping force correcting unit 32 of the damping force control unit 22 in step S4.

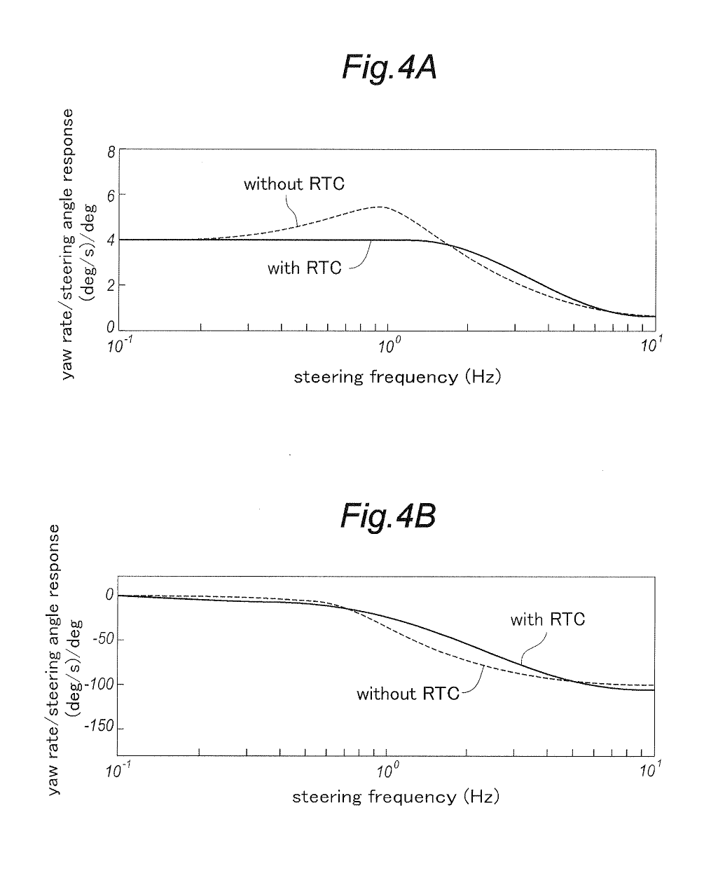

The process of correcting the damping force according to the contact load reduction command executed by the damping force correcting unit 32 is described in the following. When a cornering maneuver involving a high lateral acceleration is performed, the rear wheel steering control (RTC) is executed as a part of the reference yaw rate tracking control. As a result, the yaw rate response to the front wheel steering angle in relation to the frequency of the front wheel steering input is given as indicated by the solid line in FIG. 4A. The frequency property of the yaw rate response to the front wheel steering angle demonstrates a relatively flat gain up to about 1 Hz, and the gain gradually diminishes as the frequency of the front wheel steering input rises. On the other hand, when no rear wheel steering control (RTC) is used, the gain gradually increases as the input frequency rises from about 0.1 Hz, and relatively sharply diminishes as the input frequency rises beyond about 1 Hz.

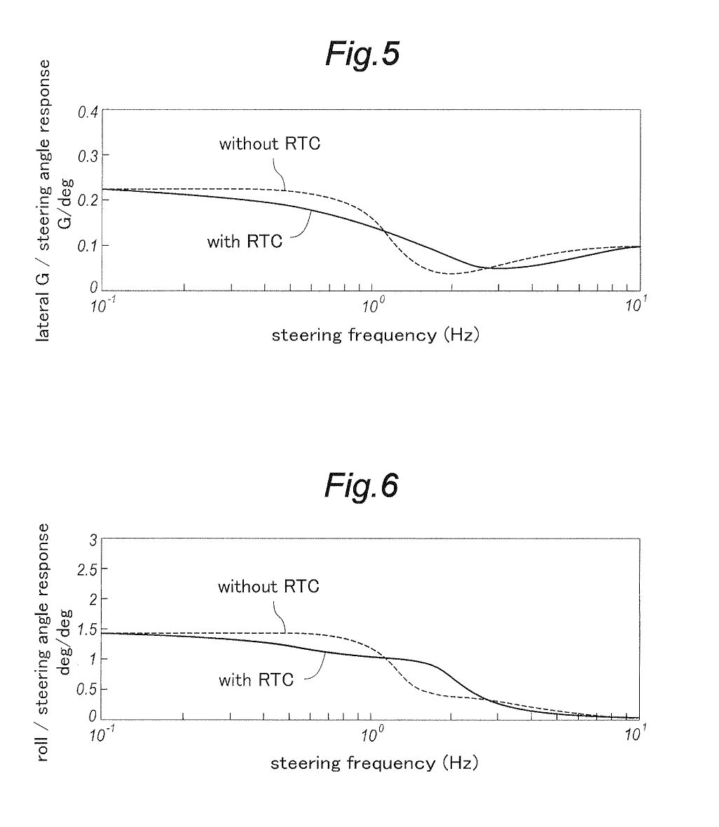

At about 1.4 Hz where the frequency response gains with and without RTC are substantially identical to each other, the yaw rate response with RTC tends to advance in phase as compared to that without RTC. At such a frequency range, when the rear wheels are steered in opposite phase relationship to the front wheels, the lateral G of the vehicle V with RTC is typically higher than that of the vehicle V without RTC as shown in FIG. 5. In other words, the use of RTC may cause an increased lateral acceleration at such a frequency range. This in turn causes the roll of the vehicle V to be increased as shown in the graph of FIG. 6, and the load of the rear wheel steering actuator 8r for the outer rear wheel to be increased.

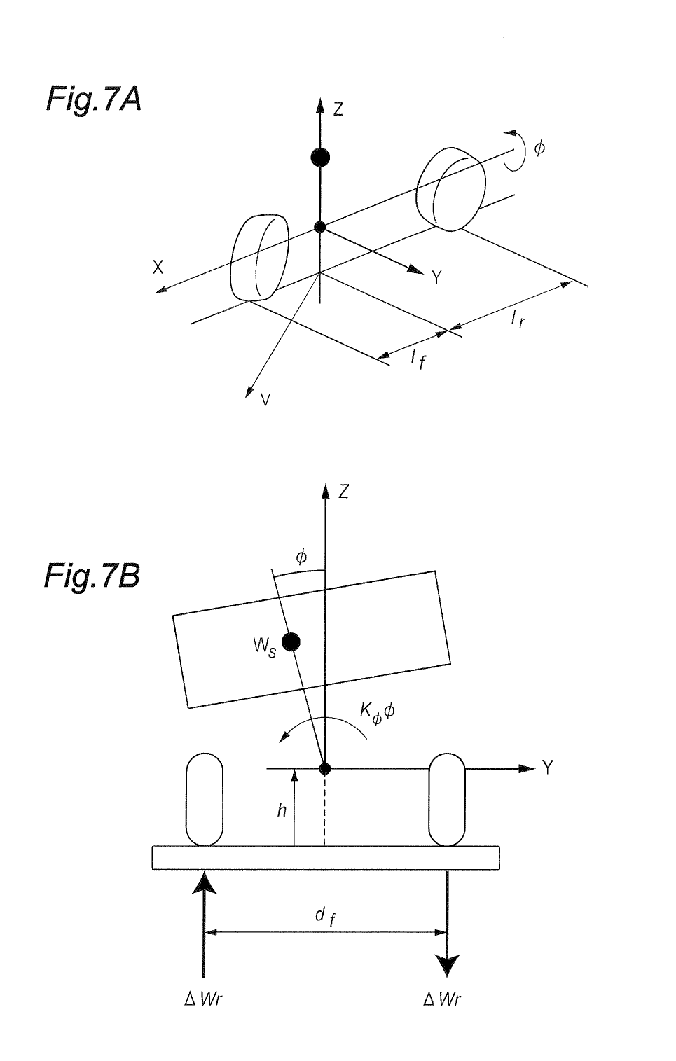

This shifting of the load to the outer rear wheel is described in the following with reference to FIGS. 7A and 7B which are a front and perspective views of a vehicle model. In the illustrated vehicle model, the shift in the rear wheel load from the inner wheel to the outer wheel can be represented as given in the following:

$$Δ {W}_{r} \cdot {d}_{r} = ( \frac{{W}_{s}}{g} \ddot{y} + {W}_{s} h φ ) \frac{{l}_{f}}{l} = {K}_{φ r} φ \qquad ( 1 )$$

where dᵣ represents the rear wheel tread, K_{φr} the rear wheel roll stiffness, φ the roll angle, y the lateral displacement, Ws the vehicle weight, l the wheel base, lf the distance between the gravitational center and front axle, and h the height of the roll center.

As can be appreciated from Equation (1), the load shift ΔWr includes a component based on the roll stiffness K_{φr} and roll angle φ. Therefore, the load shift ΔWr can be adjusted so as to reduce the contact load of one of the rear wheels if the roll stiffness K_{φr} is reduced without increasing the roll angle φ.

This can be accomplished by increasing the roll stiffness of the front part of the vehicle, and reducing the roll stiffness of the rear part of the vehicle, preferably keeping the overall stiffness of the vehicle substantially unchanged so that the roll angle of the vehicle may not be substantially affected by the changes in the front and rear parts of the vehicle. The overall roll stiffness of the vehicle can be given as a combination of the roll stiffness of the front part of the vehicle and the roll stiffness of the rear part of the vehicle. Therefore, by adequately increasing the roll stiffness of the front part of the vehicle as compared to the reduction in the roll stiffness of the vehicle, it is possible to reduce the overall roll stiffness of the vehicle without substantially changing the roll angle of the vehicle. In the illustrated embodiment, the roll stiffness levels of the front part and rear part of the vehicle can be changed by increasing the damping force of the variable dampers of the front wheel suspension systems and decreasing the damping force of the variable dampers of the rear wheels.

The damping force correcting unit 32 executes the target damping force correcting process based on this consideration as described in the following. At the beginning of a cornering action, the steering wheel is turned, and this causes an increase in the lateral force. To prevent an increase in the roll angle φ of the vehicle V, the damping force correcting unit 32 sets the correction values for the variable dampers of the four wheels such that the target damping forces of the dampers of both the inner and outer front wheels (both the contracting and extending sides) are increased and the target damping forces of the dampers of both the inner and outer rear wheels (both the contracting and extending sides) are decreased. At this time, preferably, the correction values for the front wheels are selected to be greater than those for the rear wheels so that the roll angle of the vehicle, in particular the roll angle of the rear part of the vehicle remains unchanged. By minimizing the damping force of the rear wheels or the effective roll stiffness of the rear wheels, the reduction in the road load contact load on the outer rear wheel can be maximized. However, so as not to disturb the dynamic stability and/or ride quality of the vehicle, the magnitudes of the correction values should be kept within a reasonable range.

At the end of the cornering action where the neutralization of the steering angle causes the lateral acceleration to be reduced, the target damping force correcting process is terminated, preferably gradually or in a progressive manner so that the abrupt change in the behavior of the vehicle may be avoided.

Owing to this damping force correcting process, the road contact load of the outer rear wheel is reduced, and this allows the rear wheel actuator 8 to steer the outer rear wheel with a small power output and with a small time delay. As a result, the difference Δδrr between the rear wheel target steering angle δrrt and actual rear wheel steering angle δrrr is quickly eliminated so that the overshooting of the yaw rate of the vehicle can be avoided, and the handling of the vehicle can be improved. In particular, the stability of the vehicle can be ensured even in a high lateral acceleration condition which otherwise prevents a prompt response of the rear wheel steering actuator 8.

According to a modified embodiment of the present invention which may be applied to the vehicle equipped with a rear toe control system such as the one illustrated in FIG. 1, when the vehicle is cornering, the damping force of at least one of the variable dampers of the rear wheels is reduced while the damping forces of the variable dampers of the front wheels are kept unchanged. This causes an increase in the overall roll angle of the vehicle due to the reduction in the overall roll stiffness of the vehicle, but the increase in the roll angle may be more than offset the reduction in the effective roll stiffness of the rear part of the vehicle so that the reduction in the road contact load of the outer rear wheel can be accomplished to a lesser extent than the previous embodiment, but this modified embodiment has the advantage of simplicity and reduced impact on the wheel suspension control of the vehicle.

The road contact loads were estimated from the detected lateral acceleration in the foregoing embodiment, and the lateral acceleration may be directly detected by using a lateral G sensor or may be estimated from the vehicle speed and front wheel steering. Alternatively, the load contact loads may be directly detected using load cells provided in association with the corresponding wheels or estimated from the stroke of the dampers or may be estimated from the deviation of the actual rear steering angle from a target rear steering angle commanded by the control unit. The delay in the response of the actuator 8 gives a measure of the road contact load of the corresponding rear wheel.

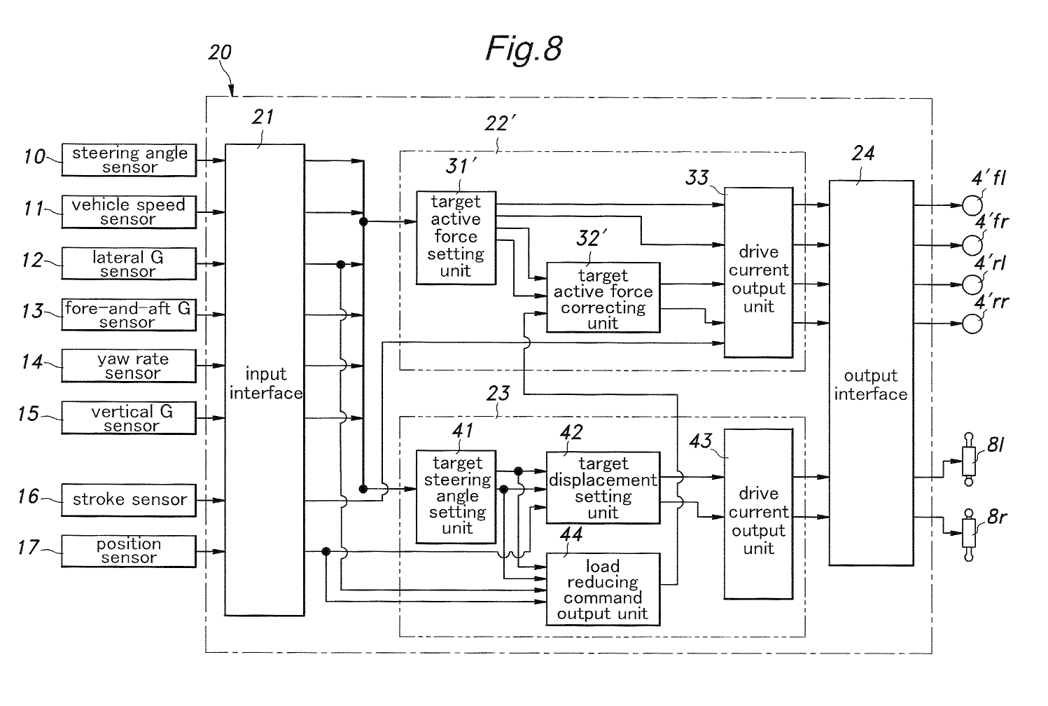

In the foregoing disclosure, the variable dampers were used for controlling the road contact loads of the wheels, but other wheel suspension elements such as actively controlled air springs and hydro-pneumatic dampers/actuator may also be used for the same purpose without departing from the spirit of the present invention. FIG. 8 shows such an embodiment, in which each wheel suspension system is provided with a hydro-pneumatic damper 4′ serving as a variable wheel suspension element. The damping force control unit 22 of the previous embodiment is replaced by an active force control unit 22′ which includes a target active force setting unit 31′ and a target active force correcting unit 32′, instead of the target damping force setting unit 31 and damping force correcting unit 32, respectively, of the previous embodiment. The mode of operation of this embodiment is similar to that of the previous embodiment except for that the hydro-pneumatic dampers 4′ are used in this embodiment, instead of the variable damping force dampers of the previous embodiment, for controlling the stiffness of each individual wheel suspension system. The roll stiffness of the front part of the vehicle and rear part of the vehicle can also be individually controlled by using active wheel suspension elements such as hydro-pneumatic dampers.

Although the present invention has been described in terms of preferred embodiments thereof, it is obvious to a person skilled in the art that various alterations and modifications are possible without departing from the scope of the present invention which is set forth in the appended claims. For instance, the sprung mass speed and/or acceleration can be detected either by using a vertical G sensor or a stroke sensor.

The contents of the original Japanese patent application on which the Paris Convention priority claim is made for the present application, as well as those of the prior art references mentioned in the present application are hereby incorporated in this application by reference.

1. A vehicle behavior control system for a vehicle including a pair of front wheels configured to be steered by a vehicle operator and a pair of rear wheels configured to be steered by a steering actuator, comprising:
a wheel suspension system supporting each wheel, the wheel suspension system including a variable wheel suspension element that can change an effective stiffness of the corresponding wheel suspension system;
a first sensor for detecting an operating condition of the vehicle;
a second sensor for detecting an increase in a road contact load of each rear wheel; and
a control unit that actuates the steering actuator according to an operating condition of the vehicle detected by the first sensor;
wherein the control unit is configured to reduce the effective stiffness of the variable wheel suspension element corresponding to at least one of the rear wheels in relation to the effective stiffness of the variable wheel suspension elements corresponding to the front wheels when the second sensor has detected an increase in the road contact load of one of the rear wheels.

2. The vehicle behavior control system according to claim I, wherein the control unit reduces the effective stiffness of the variable wheel suspension elements corresponding both the rear wheels when the second sensor has detected an increase in the road contact load of one of the rear wheels.

3. The vehicle behavior control system according to claim 2, wherein the control unit increases the effective stiffness of the variable wheel suspension elements corresponding the front wheels at the same time as decreasing the effective stiffness of the variable wheel suspension elements corresponding the rear wheels when the second sensor has detected an increase in the road contact load of one of the rear wheels.

4. The vehicle behavior control system according to claim 3, wherein the control unit increases the effective stiffness of the variable wheel suspension elements corresponding the front wheels and decreases the effective stiffness of the variable wheel suspension elements corresponding the rear wheels when the second sensor has detected an increase in the road contact load of one of the rear wheels owing to a cornering movement of the vehicle such that a roll angle of the vehicle remains substantially unchanged by the increasing and decreasing of the effective stiffness of the variable suspension elements.

5. The vehicle behavior control system according to claim 1, wherein the increasing and decreasing of the effective stiffness of the variable suspension elements by the control unit is allowed only when a deviation of an actual rear wheel steering angle of the one rear wheel effected by the actuator from a target rear steering angle commanded by the control unit is greater than a prescribed value.

6. The vehicle behavior control system according to claim 1, wherein the increasing and decreasing of the effective stiffness of the variable suspension elements by the control unit is allowed only when a deviation of an actual rear wheel steering angle of the one rear wheel effected by the actuator from a target rear steering angle commanded by the control unit is greater than a prescribed value and a lateral acceleration of the vehicle is greater than a prescribed value.

7. The vehicle behavior control system according to claim 1, wherein the variable wheel suspension element comprises a variable damping force damper.

8. The vehicle behavior control system according to claim 1, wherein the variable wheel suspension element comprises an active wheel suspension element.
